(19) United States
(12) Patent Application Publication
(10) Pub. No.: US 2026/0000556 A1
(43) Pub. Date: Jan. 1, 2026

(54) ASSISTANCE SYSTEM FOR MANUAL WHEELCHAIRS

(71) Applicant: UPEAK, COMPIEGNE (FR)

(72) Inventors: Valentin PIERRAT, SAINT-SOUPPLETS (FR); Valentin GAVROY, VANVES (FR)

(21) Appl. No.: 19/131,438

(22) PCT Filed: Nov. 21, 2023
(86) PCT No.: PCT/EP2023/082610

§ 371 Date: May 20, 2025

(30) Foreign Application Priority Data
Nov. 21, 2022 (FR) FR2212065

(51) Int. Cl. A61G 5/04; A61G 5/10

(52) U.S. Cl. CPC A61G 5/047; A61G 5/1083

(57) ABSTRACT

An assistance system for a manual wheelchair and a manual wheelchair equipped therewith, the system including a fastening base configured to be fixed to a manual wheelchair frame, a battery, a motor module including at least a first electric motor configured to drive a wheel of the motor module in rotation.

### INVENTION FIELD

The invention relates to the field of assistive devices for people with reduced mobility. More specifically, the invention concerns the field of manual and electric wheelchairs. The invention relates to assistance in moving people with reduced mobility, temporarily disabled people and the elderly.

### STATE OF THE ART

Manual wheelchairs are known to the state of the art. A manual wheelchair is a device that helps people with reduced mobility to get around. More specifically, a manual wheelchair comprises a seat on which the user sits and a backrest to support the user's back. The wheelchair also includes two main wheels located on the sides of the wheelchair, with handles enabling the user to turn the wheels to propel the wheelchair, brake it when it picks up speed, or steer it. Such wheelchairs are well known and effective for enabling people with reduced mobility, the elderly or the temporarily disabled to get around. Such wheelchairs are generally foldable or modular, to enable them to be transported in the boot of a car, for example, or to be stored compactly. However, they have several disadvantages. Firstly, such wheelchairs are only suitable for people with disorders acting on the lower limbs of the body, the user's arms being used to propel the wheelchair. Secondly, such wheelchairs are very uncomfortable when used on sloping ground, as propelling the wheelchair uphill requires a lot of energy from the user. Finally, the use of manual propulsion can generate musculoskeletal disorders such as tendonitis for regular users of such wheelchairs.

There are also electric wheelchairs. Such wheelchairs typically feature an electric motor and battery integrated into a chassis, which are generally relatively heavy. The wheelchair includes a control device, usually in the form of a joystick, enabling the user to control the wheelchair's electric motor. Such a device enables the motor(s) to be controlled in order to move the wheelchair forward and to brake the wheelchair. Such a wheelchair overcomes some of the disadvantages of the existing prior art by enabling motorized travel suitable for more people with reduced mobility, and facilitating travel on sloping ground. However, such a device remains very heavy and cumbersome. For example, when you want to move the wheelchair and its occupant, it is difficult to fold up, which requires a suitable vehicle with a large storage space and an access ramp to board the wheelchair. Similarly, such wheelchairs cannot be moved manually, especially when the battery is empty and can no longer power the wheelchair's motor. Such wheelchairs are also very expensive.

One of the objects of the invention is to overcome the drawbacks of the prior art.

### SUMMARY OF THE INVENTION

The invention relates to a manual wheelchair assistance system which comprises a fastening base configured for being fixed to a manual wheelchair frame and a motor module, said motor module comprising:
a housing comprising at least one removable fastening means configured to cooperate with an attachment means of the fastening base;
a battery;
a wheel fixed in translation relative to the housing;
at least one first electric motor.
   The wheel is driven in rotation about a first axis of rotation and about a second axis of rotation perpendicular to the first axis of rotation. The system includes means for controlling the first motor.

Advantageously, the first motor is configured to drive the wheel in rotation about the first axis of rotation.

Advantageously, the assistance system also includes a second electric motor configured to drive the wheel in rotation about the second axis of rotation.

Advantageously, the control means is a second motor control means.

The assistance system according to the invention thus makes it possible to motorize a manual wheelchair by attaching the removable means of attachment of the housing to the means of attachment of the fastening base. In this way, the system is removable from a manual wheelchair, making it quick and easy to add and remove the system from the wheelchair, enabling the wheelchair to be used both motorized and manually. Similarly, the device according to the invention is lightweight, making it easy to transport both the system and the wheelchair. What's more, the system is easy to dismantle, enabling the wheelchair to be easily stored and moved, for example in the boot of a car.

According to an embodiment, the wheel is intended to be in contact with a surface of a floor on which the wheelchair is placed when the housing is attached to the fastening base.

In one embodiment, the wheel is in contact with a surface of a floor on which the wheelchair is placed when the housing is attached to the fastening base.

In one embodiment, the wheel is mechanically connected to the housing with at least two rotational degrees of freedom.

In one embodiment, the first electric motor is configured to rotate the wheel about the first axis of rotation, and the assistance system further comprises a second electric motor configured to rotate the wheel about the second axis of rotation.

In one embodiment, the first motor is integrated into the wheel.

In one embodiment, the second motor is integrated with the housing.

In one embodiment, the removable attachment means comprises at least one hook, and wherein the attachment means comprises at least one rod configured to cooperate with the hook and establish the releasable attachment.

In one embodiment, the removable fastening means comprises at least one hook, the attachment means comprises at least one rod configured to cooperate with the hook to removably connect the removable fastening means and the attachment means.

According to one embodiment, the first axis of rotation of the wheel is perpendicular to a principal plane of said wheel, and wherein the first electric motor is controlled to enable propulsion and braking of the wheel.

In one embodiment, the first electric motor enables the wheelchair to move backward. In other words, the first electric motor is configured to drive the wheel in rotation about the first axis of rotation relative to the housing in a first direction and in a second direction.

According to an embodiment, the first axis of rotation of the wheel is perpendicular to a principal plane of said wheel, and the first electric motor is controlled in speed, position and/or torque to drive the wheel in rotation about the first axis of rotation relative to the housing in a first direction and/or in a second direction opposite to the first direction.

In one embodiment, braking by the first motor is regenerative braking to recharge the assistance system battery.

In one the assistance system comprises a controller controlling the rotation and/or braking of the first motor.

In other words, the controller is configured to control the rotation and/or braking of the first motor.

In one embodiment, the system comprises a controller and a set of at least one sensor comprising at least one sensor of rotational speed and/or torque and/or angular position of the wheel about the first axis relative to the housing, the controller receiving at least one item of information from at least one sensor of the set and being configured to control the first motor as a function of said at least one item of information.

In one embodiment, the removable fastening means and/or the attachment means comprise at least one magnet configured to maintain contact between a contactor of the attachment means and a contactor of the removable fastening means.

In one embodiment, the controller comprises a user interface including means for controlling the propulsion and/or braking of the assistance system.

In one embodiment, the system comprises a user interface enabling a user to send at least one setpoint, the controller being configured to control the operation of the first motor as a function of the setpoint.

The invention also relates to a manual wheelchair which comprises an assistance system according to the invention and in which the fastening base is fixed to a frame of the manual wheelchair.

### BRIEF DESCRIPTION OF FIGURES

Further features and advantages of the invention will become apparent from the following detailed description, with reference to the appended figures, which illustrate:

FIG. 1: A perspective view of a manual wheelchair assistance system according to one embodiment of the invention.

FIG. 2: a perspective view of a motor module of the manual wheelchair assistance system as shown in FIG. 1.

FIG. 3: A front view of the motor module of the manual wheelchair assistance system as shown in FIG. 1.

FIG. 4: A profile view of the motor module of the manual wheelchair assistance system as shown in FIG. 1.

FIG. 5: A perspective view of a fastening base for the manual wheelchair assistance system as shown in FIG. 1.

FIG. 6: A perspective view of a manual wheelchair equipped with an assistance system according to one embodiment of the invention.

FIG. 7: a perspective view of a detail from FIG. 4.

FIG. 8: A perspective view of a motor module of the assistance system according to one embodiment of the invention, with part of the housing missing.

FIG. 9: A perspective view of a removable fastening means for the assistance system fixed to a chair according to one embodiment of the invention.

FIG. 10: A perspective view of a fastening base for the assistance system according to one embodiment of the invention.

FIG. 11: A profile view of a removable fastener according to one embodiment of the invention.

### DESCRIPTION OF THE INVENTION

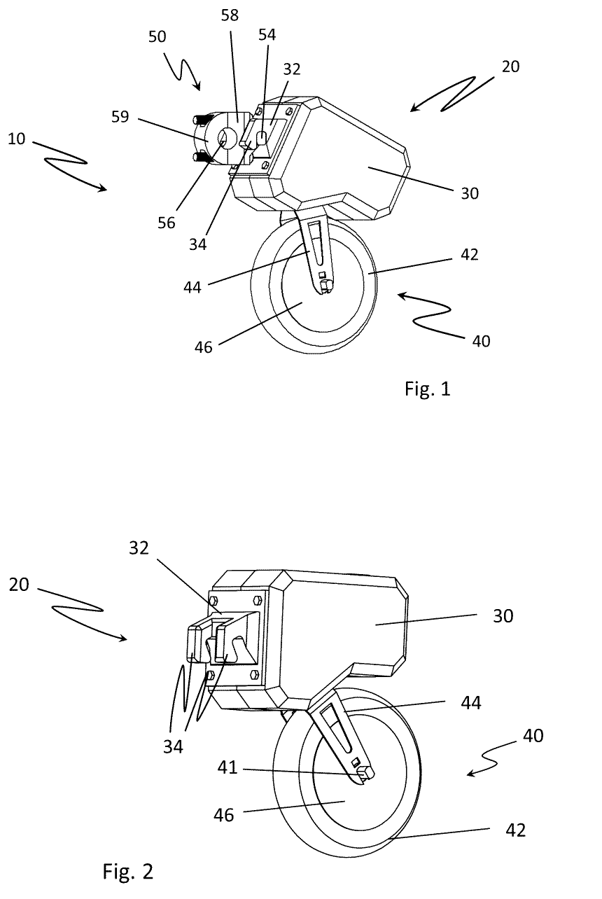

FIG. 1 shows an example of an assistance system 10 for a manual wheelchair. In this figure, the assistance system is shown in perspective.

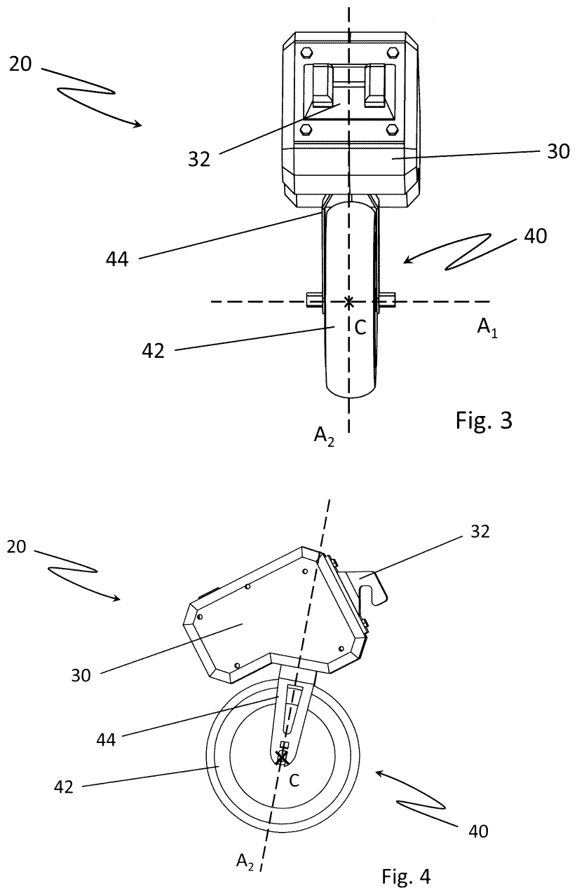

The assistance system 10 according to the invention comprises a motor module 20. FIGS. 2, 3 and 4 show a perspective view of the motor module 20. The motor module 20 comprises a housing 30. The housing 30 comprises a rigid envelope protecting at least one or more components located inside it. By housing 30 we also mean a frame for the motor module 20.

The housing 30 of the motor module has at least one removable fastening means 32.

In other words, the motor module 20 advantageously comprises a fastening means, i.e. a first fastener.

This fastening means is fixed in relation to the housing 30.

This removable fastening means 32 is preferably fixed to an external surface of the housing 30.

In one embodiment, the removable fastening means 32 is integrated into the housing 30. The assistance system 10 comprises a wheel 40.

The wheel 40 preferably comprises a tire 42. By tire 42 we mean a circular tire made of rubber and other textile and/or metallic materials. Alternatively, the tire 42 can be made of plastic. The tire can be inflated with air, for example, or filled.

The wheel 40 is generally disc-shaped.

The wheel 40 thus has a main plane, in which the rays of the disk formed by said wheel 40 lie.

The wheel 40 is fixed in translation relative to housing 30.

By fixed in translation, we mean that the wheel 40 is enabled to move in translation along a translation axis with respect to the housing 30.

The motor module 20 of the assistance system 10 comprises at least a first electric motor 46.

The first electric motor 46 is configured to transform electrical energy into rotary motion. In other words, the first motor 46 is configured to supply mechanical energy to the assistance system 10. The assistance system 10 includes a battery. By battery, we mean any electrical energy storage system. A battery can therefore be a cell or an accumulator. The battery is configured to electrically power at least the first electric motor 46.

The assistance system 10 comprises a fastening base 50. The fastening base 50 is configured to be fixed to a wheelchair 60. Preferably, the fastening base 50 is configured to be fixed to a frame 62 of wheelchair 60, but can be fixed to any other part of wheelchair 60.

The wheelchair comprises main wheels 64 designed to rotate about an axis of rotation relative to the frame 62 so as to move the wheelchair along a travel axis of wheelchair travel.

Advantageously, the axis of travel of the wheelchair is perpendicular to the axis of rotation of the wheelchair's main wheels.

Preferably, the fastening base 50 is fixed to a manual wheelchair 60.

Like the entire assistance system 10, the fastening base 50 can also be fixed to a non-manual wheelchair, such as an already motorized wheelchair. In addition, the system can be fixed to any type of moving or handling means, such as a cart.

Advantageously, the fastening base 50 is designed to be removably attached to the housing 30.

The fastening base 50 comprises an attachment means 52 or second fastener. By attachment means 52 or second fastener, we mean any means to which the removable fastening means 32 of the housing 30 or fixed with respect to the housing can be attached, or fastened, with the aim of connecting the housing to the said fastening base 50.

By connecting the case to the fastening base we mean establishing a mechanical connection.

Advantageously, the attachment means 52 and the removable fastening means 32 are designed to cooperate to establish a pivot connection between the fastening base 50 and the motor module 20

Advantageously, the pivot connection allows the motor module 20 to rotate relative to the fastening base 50 about an axis parallel to the axis of rotation of the main wheels 64 of the wheelchair 60 on which the system 10 is installed.

By removable fastening, we mean a connection made between the removable fastening means 32 and the fastening base 50 which enables these two elements to be connected, while retaining the possibility of easily separating said elements.

In other words, the removable fastening means 32 is designed to cooperate with the attachment means 52 to releasably connect the housing 30 to the fastening base 50.

In other words, the motor module 20 can be easily installed and removed from the fastening base 50.

Advantageously, the attachment means 52 of the fastening base 50 allows a rotational movement of the motor module 20, enabling a vertical movement of the wheel 40, relative to the floor on which the wheelchair rests. In this way, the rotation of the wheel 40 allows the motor module 20 to be raised to pass obstacles in its path. This rotation is made possible by the pivot connection formed by the removable attachment means 32 and the attachment means 52 between the fastening base 50 and the motor module 20

Preferably, the fastening base 50 is fixed to the frame 62 of the wheelchair 60.

Advantageously, this fastening base 50 can be removed from the wheelchair frame 60.

In other words, the fastening base is designed to be removably attached to the frame 62 of the wheelchair 60.

In other words, attaching the fastening base 50 does not damage the frame 62 of the wheelchair 60.

The wheel 40 is in contact with the surface of a floor on which the wheelchair 60 is standing when the system is installed on the wheelchair 60.

In other words, the system 100 is advantageously configured to be mounted on the frame 62 of the wheelchair 60 so that the wheel 40 is in direct physical contact with the ground on which the wheelchair 60 rests.

The wheel 40 is rotatable relative to the housing 30 about a first axis of rotation A₁.

In this patent application, rotation along an axis is taken to mean rotation about an axis.

The first axis of rotation A₁ is substantially perpendicular to a main plane of the wheel 40.

The main plane of the 40 wheel has been defined above.

Preferably, the first axis of rotation A₁ passes through a point C which is substantially the center of the wheel 40.

The wheel is rotated about the first axis of rotation A₁ by the assistance system 10.

More precisely, the first motor 46 is designed to drive the wheel in rotation about the first axis of rotation A₁ relative to the housing 30.

This rotation of the wheel 40 about the first axis A₁ enables propulsion of a manual wheelchair 60 on which the assistance system 10 would be installed.

Advantageously, the axis of rotation A₁ is intended to be parallel to an axis of rotation of the main wheels 64 of the wheelchair 60 when the system 10 is installed on the wheelchair 60.

In the same way, the rotation of wheel 40 enables the wheelchair 60 to be braked when it is already moving in translation.

The wheel 40 is rotatable relative to the housing 30 about a second axis of rotation A₂.

Advantageously, the second axis of rotation A₂ is perpendicular to the first axis of rotation A₁.

In other words, the second axis of rotation A₂ lies in the main plane of the wheel 40.

Thus, rotation of the wheel 40 about the second axis of rotation A₂ allows the main plane of said wheel 40 to pivot.

This rotation of the wheel 40 about the second axis of rotation takes place relative to the housing 30.

Thus, when the system is installed on a wheelchair 60 and the wheelchair moves forward, rotation of the wheel about the second axis of rotation A₂ allows its main plane to pivot so that it is not aligned with the movement of the wheelchair 60. As a result, rotation of the wheel 40 about the second axis of rotation A₂ allows the wheelchair to turn as it moves forward. In other words, this rotation enables the wheelchair 60 to move from a rectilinear to a circular motion. The system according to the invention is ideally suited for removable attachment to a wheelchair.

In other words, the system 10 or device 10 is designed to be removably attached to a frame 62 of a wheelchair 60.

In this way, the system can be removed when the user does not wish to have motorization on his wheelchair, and replaced when the need for motorization arises. Likewise, the ability to remove the motorization makes it easier to store the wheelchair, particularly for travel purposes. Once the motor module 20 has been removed from the wheelchair, it can be folded up or dismantled as normal, for example for storage in a vehicle boot. Similarly, the motor module 20 can be easily stored, as it can be separated from the wheelchair. Lastly, the system according to the invention provides a removable motorization system that enables the wheelchair to be propelled about both a straight and a circular trajectory, by adjusting the direction of propulsion. In this way, the user can easily take bends with a wheelchair equipped with the assistance device, without having to use his upper limbs to act on the wheelchair's side wheels.

In one embodiment, the system enables the wheelchair to be propelled in a first direction and in a second direction along an axis perpendicular to the first axis A₁ when the system is mounted on the wheelchair 60.

In other words, the system according to the invention is designed to move the wheelchair forwards and backwards.

In one embodiment, the first electric motor enables the wheelchair to which it is attached to moves backward.

In other words, the first electric motor 46 is able to rotate the wheel 40 about the first axis of rotation A₁ relative to the housing 30 in a first direction and in a second direction opposite to the first direction.

### Motorization

In one embodiment, the system 10 includes a second electric motor 48. The second electric motor 48 can be seen in FIG. 8, which is a perspective view of the motor module 20 in its housing 30, said housing 30 being open.

In this embodiment, the second electric motor 48 drives the rotation of the wheel 40 about the second axis of rotation.

According to this embodiment, it is therefore the second motor 48 that activates a circular trajectory of the wheelchair 60 when the latter is in motion by pivoting the wheel 40.

In one embodiment, the first electric motor 46 rotates about the first axis of rotation A₁ only. In this embodiment, it is the first motor 46 that propels the wheelchair 60 by rotating the wheel 40.

In one embodiment, the first electric motor 46 is integrated into the wheel 40.

In other words, the first electric motor 46 is located in the wheel 40, between the first axis of rotation A₁ and the tire of said wheel 40. In this way, the system is more compact than a system with a remote motor. Similarly, the fact that the motor is integrated into the wheel 40 eliminates the need for a transmission system, making the system lighter and less expensive.

In one embodiment, the first motor 46 is a DC motor.

In one embodiment, the first electric motor is a brushless motor. Brushless motors are reliable and require less maintenance than motors with brushes.

In one embodiment, the second motor 48 is located within the housing 30. In this way, the second motor is positioned for easy control of rotation about the second axis of rotation A₂.

In one embodiment, the second motor 48 directly rotates the wheel about the second axis of rotation A₂

Direct rotation means that a motor shaft of the second motor is connected to the wheel 40 so that the motor shaft rotates at the same speed as the wheel 40 around the second axis of rotation A₂.

In one embodiment, the motor module 20 includes a fork 44. The fork 44 is intended to connect the wheel 40 to the housing 30 of the motor module 20.

Advantageously, the fork 44 is linked to the housing 30 by a pivot connection. This pivot connection enables the fork to rotate relative to the housing 30 about the second axis of rotation A₂.

Advantageously, the fork 44 is linked to the wheel 40 by a pivot connection. This pivot connection allows rotation of the wheel 40 relative to the fork 44 about the axis A₁

Preferably, the fork 44 has two arms, each being linked to a rotation shaft 41 of the wheel 40 at the first rotation axis A₁.

The two arms grip the wheel 40.

In one variant, the fork 44 has a single arm.

In one embodiment, the second motor 48 is directly connected in rotation to the fork 44 of the wheel 40

In other words, the second motor 48 directly rotates the fork 44 relative to the housing about the second axis A₂.

This arrangement enables to directly rotate the wheel 40 about the second axis of rotation A₂.

In one embodiment, a gearbox is placed between the wheel 40 and the second motor 48. In other words, the gearbox enables the speed of rotation supplied by the second motor 48 to be adapted to the rotation of the wheel 40 about the second axis of rotation A₂. In this way, the speed of rotation can be adapted to impart the desired movement to fork 44 when the wheelchair is desired to turn.

In one embodiment, the motor module 20 of system 10 comprises the battery.

In one embodiment, the housing 30 of the module 20 of the system contains the battery. In this embodiment, the battery is integrated with the housing 30 and is integral with it.

In one embodiment, the battery is removable from the motor module 20.

This feature enables the battery to be changed quickly. In one embodiment, the battery is removable from the housing 30.

In this way, the battery can be easily removed and returned to the motor module 20. In this way, when the battery runs out of electrical energy, it can easily be replaced by a battery that is charged. The battery can then be recharged and the system 10 according to the invention can continue to be used.

In one embodiment, the motor module 20 comprises an electrical connection. The electrical connection enables the battery to be connected to a power source. This connection enables the battery to be recharged.

In one embodiment, the electrical connection of housing 30 comprises at least one magnet configured to cooperate with a magnet of a connecting cable. In this way, when the cable is connected to the electrical connection, it is held in the connection by magnetic interaction. In the same way, abrupt removal of the cable from the connection is possible without damaging the cable and/or the electrical connection.

According to an embodiment, the electrical connection of the housing 30 comprises at least one USB-C type connection. This type of connection is ideal for transferring data from a computer and/or cell phone to the housing 30. For example, this may enable updates to be made to software controlling the assistance system 10. The connection can be made by any type of electrical connection that will be considered by the person skilled in the art, more particularly by any type of connection enabling the transfer of electrical energy and the transfer of data.

In one embodiment, the first motor 46 is electrically controlled.

Advantageously, the system includes at least one controller configured to control the first motor 46

In general, the controller is configured to perform the controls described in this patent application.

The system advantageously comprises a set of at least one sensor for measuring a physical quantity representative of a state of the system.

The system 10 is advantageously configured so that a measurement of a physical quantity delivered by at least one sensor of the set is transmitted to the controller and so that the controller controls the first motor as a function of said information.

The system 10 is advantageously configured so that a measurement of a physical quantity delivered by at least one sensor of the set is transmitted to the controller and so that the controller controls the first motor as a function of said information and as a function of a set value of the physical quantity.

The control of the first electric motor 46 provides good control of its operation, and therefore stability in the propulsion of the assistance system 10. In one embodiment, the first motor 46 is controlled in speed. Such a control system enables precise control of the rotation speed of the first motor 46, and therefore, by extension, precise control of the forward speed of the wheelchair on which the assistance system 10 is installed.

Advantageously, the motor module 46 comprises a sensor for measuring the speed of rotation of wheel 40 about axis A₁ relative to the housing 30. The rotation speed measurement is transmitted to the controller, which is configured to control the motor as a function of this measurement.

In one embodiment, the first motor 46 is position-controlled.

Advantageously, the motor module 46 includes a sensor for detecting the angular position of wheel 40 about axis A₁.

The position measurement is transmitted to the controller, which is configured to control the motor according to this measurement.

In one embodiment, the first motor 46 is torque-controlled.

The motor module 46 advantageously includes a torque sensor for the first motor 46.

The torque measurement is advantageously transmitted to the controller, which is configured to control the motor as a function of this measurement

In one embodiment, the first motor 46 is torque-and speed-controlled.

In one embodiment, the first motor 46 is speed-and position-controlled.

In one embodiment, the first motor 46 is torque-and position-controlled.

In one embodiment, the first motor 46 is speed-, position-and torque-controlled.

In one embodiment, the first motor 46 is configured to perform motor braking.

In other words, the first motor 46 can operate alternately as a motor and as a brake.

The motor brake brakes the movement of the wheelchair 60 when the first motor 46 is activated.

The use of the first motor 46 as a brake advantageously dispenses with the need for mechanical braking using wear parts requiring maintenance.

Braking also enables the wheelchair user 60 to negotiate sloping paths safely.

In one embodiment, braking by the first motor 60 is regenerative braking. Regenerative braking means recovering the electrical energy generated by the first motor 46 during braking.

In other words, the first motor 46 can operate alternately as a motor and a generator.

Advantageously, the electrical energy generated by braking is used to recharge the battery of the assistance system 10. This arrangement increases the autonomy of the assistance system 10.

In one embodiment, the second motor 48 is electrically controlled. The control of the second electric motor 48 allows good control of its operation, and therefore stability in the control of the direction of the assistance system 10. In one embodiment, the second motor 48 is position-locked. This allows precise control of the angular position of the rotation shaft of the second motor 48, and therefore, by extension, precise control of the angular orientation of the wheel 40 about the second axis of rotation A₂. This effectively controls the turning radius of the wheelchair 60 on which the assistance system 10 is installed. In one embodiment, the second motor 48 is speed-controlled. In one embodiment, the second motor 48 is torque-controlled. In one embodiment, the second motor 48 is torque-and speed-controlled. In one embodiment, the second motor 48 is speed-and position-controlled. In one embodiment, the second motor 48 is torque and position controlled. In one embodiment, the second motor 48 is speed-, position-and torque-controlled.

In one embodiment, the turning radius defined by the angular orientation of the wheel 40 about the second axis of rotation A₂ is changed according to the forward speed of the wheelchair 60 equipped with the system 10 In other words, the angle of the wheel 40, when turning, can be adjusted according to the speed of the wheelchair.

In other words, the controller is configured to adjust the angle formed between the main plane of the wheel 40 and a plane comprising a longitudinal axis of the motor module 32 as a function of the speed of rotation of the wheel 40 about the first axis of rotation A₁ relative to the housing 30. By longitudinal axis of the motor module is meant an axis which is perpendicular to the axis of rotation of the main wheels of the wheelchair 60 when the motor module is mounted on the wheelchair 60.

In one embodiment, the controller is configured to adapt the control of the second motor as a function of a measurement of the speed of rotation of the wheel 40 about the first axis A₁ relative to the housing, delivered by the speed sensor

In this way, a very short radius of curvature can be used to make a sharp turn when the wheelchair is moving slowly, and a larger radius of curvature when the wheelchair 60 is moving at higher speed. This arrangement avoids the need to make sharp turns when the wheelchair 60 is travelling at maximum speed. This reduces the risk of the wheelchair 60 tipping over when turning.

In one embodiment, the first motor 46 is controlled so as to enable the wheelchair on which the assistance system 10 is installed to be pulled by its feet.

Pod traction refers to the fact that a user seated on the wheelchair 60 uses his/her feet to provide propulsion for the wheelchair. In other words, the user takes steps that cause the wheelchair 60 to move. In particular, this is the type of use of a wheelchair 60 by people still have sufficient muscular capacity to provide propulsion with their feet, but insufficient to stand upright.

In one embodiment, the first motor 46 is controlled to assist the pod traction performed by the user.

In one embodiment, the first motor comprises at least one angular position sensor around the first axis of rotation A₁ of the wheel relative to the housing 30, or relative to the fork 44.

The angular position measured by the sensor is transmitted to the controller, which issues a command to the first motor as a function of the measured position.

The sensor controls the position of the first motor 46.

In one embodiment, the first motor 46 comprises at least one sensor for detecting the speed of rotation of the wheel 40 about the first axis of rotation relative to the fork 40.

The speed measured by the sensor is transmitted to the controller, which sends a command to the first motor based on the measured speed.

This arrangement enables the speed of the first motor 46 to be controlled.

This arrangement also makes it possible to take into account a rotation initiated by the user's podal traction.

In one embodiment, the first motor comprises at least one torque sensor.

The torque sensor enables torque control of the rotation of the wheel 40 relative to the fork 44 around the first axis of rotation A₁.

In one embodiment, the torque sensor measures the torque supplied by the user to the wheel 40 through his or her foot traction

The torque measurement is transmitted to the controller, which adapts the control of the first motor according to the measured torque

In one embodiment, the control of the first motor is adapted to the pod traction provided by the user and adapts the torque provided by the first motor so that the system 10 provides propulsion to accompany the movement imparted by the user.

In one embodiment, the wheel 40 comprises at least one sensor for detecting the speed of rotation of said wheel 40 about the first axis A₁.

When the user pulls on the foot, the rotation sensor measures the speed of rotation of wheel 40.

Advantageously, the controller comprises at least one computer integrated into the wheel 40.

This computer is integrated into the wheel 40, for example, and receives the speed value measured by the speed sensor.

In one embodiment, the wheel 40 computer controls the rotation of the wheel 40 according to the speed value measured by the sensor.

In one embodiment, the ECU compares the speed received from the speed sensor with a predefined speed threshold. The ECU controls the rotation of the first motor so as to reach the predefined speed. If the preset speed is exceeded, the ECU stops powering the first motor, so that wheel 40 is freewheeling. The advantage of this arrangement is that it facilitates pod-pull starting without exceeding a predefined speed threshold.

According to one example, the predefined speed threshold is less than or equal to 2 kilometers per hour.

Advantageously, the wheel speed sensor is a Hall-effect sensor.

In one embodiment, the wheel 40 comprises at least one mechanical torque sensor at the first axis of rotation A₁.

When the user pulls on the pod, the torque sensor measures the mechanical torque supplied by the user.

Advantageously, the wheel computer controls the first motor so as to supply a motor torque equal to the torque supplied by the user's foot traction. In this way, the controlled rotation of the wheel follows the movement imparted to the wheelchair by the user's foot traction.

One advantage of the system 10 assisting podal traction is that it makes it easier for the user to initiate the movement, while avoiding exceeding a speed set by the user. This reduces user fatigue by lowering the effort required, while reducing the risk of injury.

In one embodiment, the wheel 40 is rotated by the second motor 48 to an angular orientation in which the wheelchair 60 can turn on the spot. In this configuration, the wheel 40 is rotated by an angle close to 90° with respect to the position of said wheel 40 in a straight line.

The position of the wheel 40 in a straight line is defined as the position of the wheel 40 in which its main plane is perpendicular to the axis of rotation of the wheels 64 of the wheelchair 60.

This is particularly useful when the wheelchair 60 needs to turn in tight spaces. The 60 wheelchair's maneuverability is therefore greatly improved by this arrangement.

### Fixation

The removable fastening means 32 of the motor module 20 is advantageously attached to the housing 30 or integrated into the housing.

FIG. 2 shows a motor module 30 of the assistance system 10.

Preferably, the removable fastening means 32 comprises a plate serving as a base for fastening it to the housing 30. Advantageously, the plate of the removable fastening means 32 is screwed onto the housing 30.

In one embodiment, the fastening means comprises at least one hook 34. The hook 34 advantageously comprises a beak which is the end part of said hook 34. The hook advantageously comprises a base which is the end part of the hook 34 which is connected to the plate serving as a base for the removable fastening means 32. The hook 34 has advantageously a seat, which is the part of the hook located between the beak and the base into which the hook 34 is bent. This part is used to receive an element of the fastening base 50 to carry out the removable attachment.

Hook 34 is configured to cooperate with attachment means 52 on fastening base 50.

The hook is an advantageous shape for absorbing forces in the direction of travel of the wheelchair 60 to which the assistance system 10 is attached.

In other words, the hook is an advantageous shape for absorbing forces along a longitudinal axis of the motor module 20.

Hook 34 is oriented so that its tip points vertically downwards.

In other words, the beak of the hook 34 is oriented substantially towards the wheel 40 of the motor module 20. Advantageously, the beak of hook 34 forms a substantially horizontal surface when the assistance system 10 is installed on a wheelchair 60, and the wheelchair is placed on a horizontal surface. In this way, the hook 34 is able to take up vertical forces when the wheelchair 60 is placed on a horizontal surface. In this way, the hook 34 ensures the balance of motor module 30 when it is attached to wheelchair 60.

In one embodiment, the removable fastening means 32 on the motor module 20 comprises at least two hooks 34.

In one embodiment, the two hooks 34 are positioned to be vertically at the same level on the housing 30, when the assistance system 10 is installed on the wheelchair 60 and the wheelchair 60 is placed on a horizontal surface.

The two hooks 34 are only horizontally offset from each other when the system is attached to a wheelchair 60. Having two hooks 34 makes for a more robust attachment and also ensures greater stability of the motor module 20 once it has been attached to the wheelchair 60. The fact that the two hooks are laterally offset also makes it possible to take up torques that would be oriented substantially along a vertical axis when the system 10 is attached to the wheelchair 60.

Advantageously, the frame 62 is a tubular element connecting the two main wheels of the wheelchair.

The frame 62 advantageously extends longitudinally along a longitudinal axis of the tubular element being an axis of rotation about which the wheels 64 are intended to rotate relative to the wheelchair frame 60.

The tubular element is designed to be horizontal when the wheelchair 60 is placed on its wheels 64 on a flat horizontal surface, such as a floor.

Horizontal at a point means a direction perpendicular to the gravitational force at that point.

The axis of rotation of wheels 64 is preferably perpendicular to a main axis of travel of wheelchair 60.

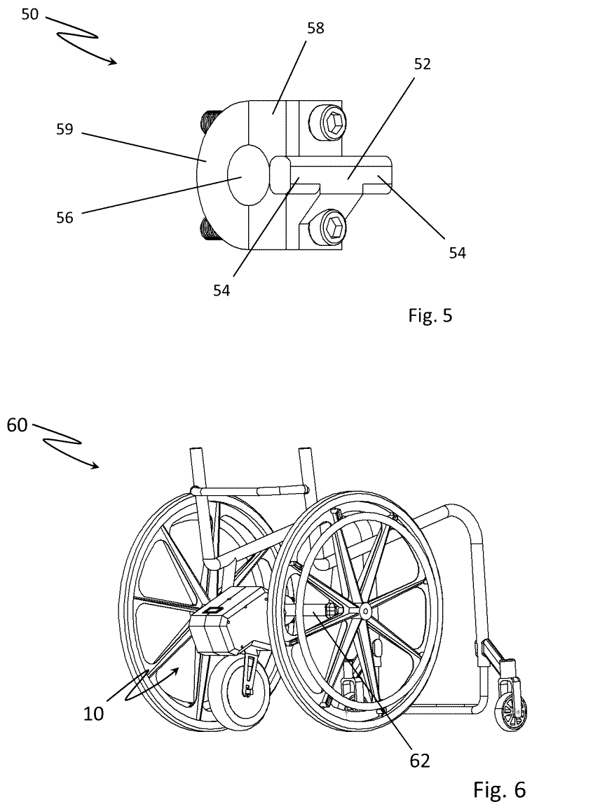

FIG. 5 shows a fastening base 50 of an assistance system 10 according to the invention. The fastening base 50 is preferably attached to a tubular element of the frame 62 of the wheelchair 60.

More specifically, the fastening base 50 preferably comprises a cavity 56 sized to accommodate a tubular frame member 62.

Preferably, the fastening base 50 is clamped tightly around the tubular element of the frame 62. In this way, the fastening base 50 is fixed in position onto the frame 62 and can serve as an attachment element for the motor module 20 onto the frame 62 of the wheelchair 60.

In one embodiment, a crossbar is added to the frame of the wheelchair 60. According to this embodiment, the fastening base 50 is fixed to the crossbar which is added to the frame 62 of the wheelchair 60.

This arrangement is particularly advantageous when the wheelchair 60 has a folding frame which is cross-shaped and therefore offers no substantially horizontal tubular element when the wheelchair is placed on a flat horizontal surface to which to attach the fastening base 50.

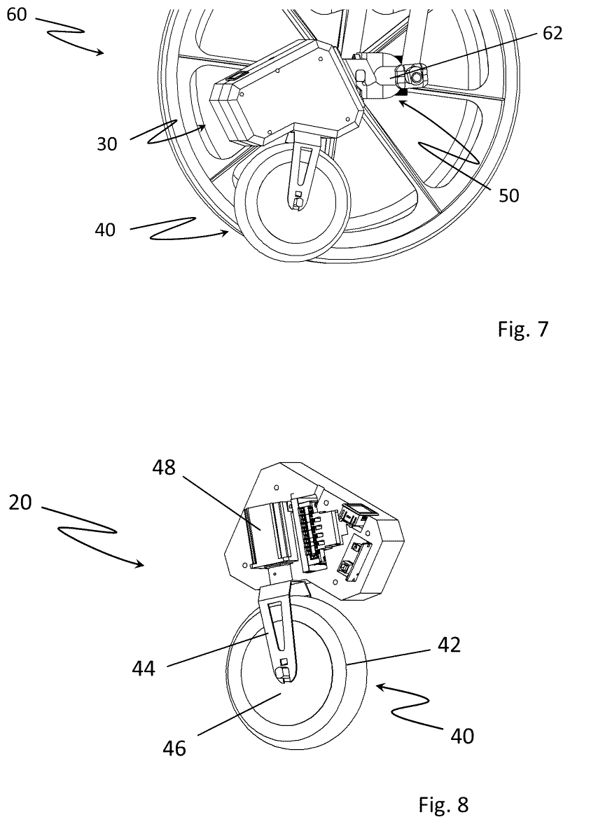

In one embodiment, the fastening base 50 comprises two detachable parts 58, 59. The fastening base 50 comprises an attachment part 58 and a docking part 59. The attachment part 58 comprises the attachment means 52. A separation between docking part 59 and attachment part 58 is formed at a cavity 56. More precisely, the separation divides the cavity 56, which is cylindrical in shape, in two parts. The separation passes through a radial plane of the cylinder formed by cavity 56, cutting it to form two half-cylinders. In this way, when fixing the fastening base 50 to the frame 62, it is sufficient to separate the two parts 58, 59 and place them around the tubular element of the frame 62 to enclose said tubular element. In this way, the fastening base 50 forms a jaw around the tubular frame element 62. Such an arrangement can be seen in particular in FIGS. 6 and 7, which are views of the assistance system 10 installed on a wheelchair 60. Advantageously, the fastening base comprises at least one threaded hole running through the attachment part 58 and the docking part 59. Advantageously, the fastening base 50 has two threaded holes, each of which passes through the attachment part 58 and the docking part 59. The fastening base 50 comprises at least one screw, preferably two, configured to cooperate with the threaded hole in fastening base 50 to hold the fixing part 50 and the docking part 59 together. In this way, it is possible to clamp the fastening base 50 around the tubular element of the frame 62 of the wheelchair 60.

In one embodiment, the fastening base is directly integrated into the frame 62 of the wheelchair 60. In this way, no installation is required for the fastening base 50. For example, the frame 62 directly comprises a part projecting from the body of the frame 62. The projecting part of the frame comprises the attachment means 52 of the fastening base 50.

Advantageously, the system is configured so that the fastening base 50 and the removable fastening means 32 are intended to cooperate so that the fastening means 32 is in pivotal connection with the fastening base 50 about an axis of rotation of the fastening means 32 parallel to the longitudinal axis of the frame 62 when the system 10 is mounted on the chair 60, i.e. on the frame 62.

In one embodiment, the attachment means 52 of the fastening base 50 comprises at least one rod 54. The rod 54 is configured to cooperate with a hook 34 of the removable fastening means 32 of the motor module 20. In one embodiment, attachment means 52 of fastening base 50 comprises at least two rods 54.

We will now describe the interaction between the removable fastening means 32 of the motor module 20 and the attachment means 52 of the fastening base 50.

When the fastening base 50 is fixed to the frame 62 of the wheelchair 60, a user approaches the removable fastening means 32 of the attachment means 52. The hook(s) 34 of fastening means 32 are brought into alignment with the rod(s) 54 of attachment means 52. The rods 54 are then inserted into the part of the hooks 34 forming the seats of said hooks 34. Once the rods 54 have been inserted, the system is in the position shown in FIG. 1. It can be seen that this fastening is removable, as the hooks 34 are easy to insert and remove from the rods 54 of the attachment means 52. The operations of attaching and removing the motor module 20 from the assistance system 10 can therefore be carried out without the use of any special tools. A user can therefore perform this operation easily and quickly. The fastening system described here also has the advantage of effectively securing the motor module 20 and fastening base 50, while remaining slightly mobile. This arrangement has the advantage of enabling fastening without creating high internal stresses which could damage the fastening means. What's more, the mobility provided by the fastener means that contact between the wheel 40 and the ground on which the wheelchair is moving is maintained at all times.

Advantageously, this means of attachment 52 of the fastening base 50 allows a rotational movement of the motor module 20, enabling a vertical movement of the wheel 4, relative to the ground on which the wheelchair rests. In this way, the rotation of the wheel 40 allows the motor module 20 to be raised to pass obstacles in its path

Advantageously, this rotation takes place around an axis parallel to the axis of rotation of the main wheels 64 of the wheelchair 60 on which the system 10 is installed.

In one embodiment, the removable fastening means comprises a magnet. By electromagnetic interaction, the magnet creates a holding force between the fastening means 32 and the attachment means 52. Alternatively or additionally, the attachment means 52 of the fastening base 50 comprises a magnet to create a holding force between the attachment means 52 and the removable fastening means 32

Advantageously, the attachment means comprises at least in part a ferromagnetic material. In this way, an attractive force is created between the magnet and the attachment means.

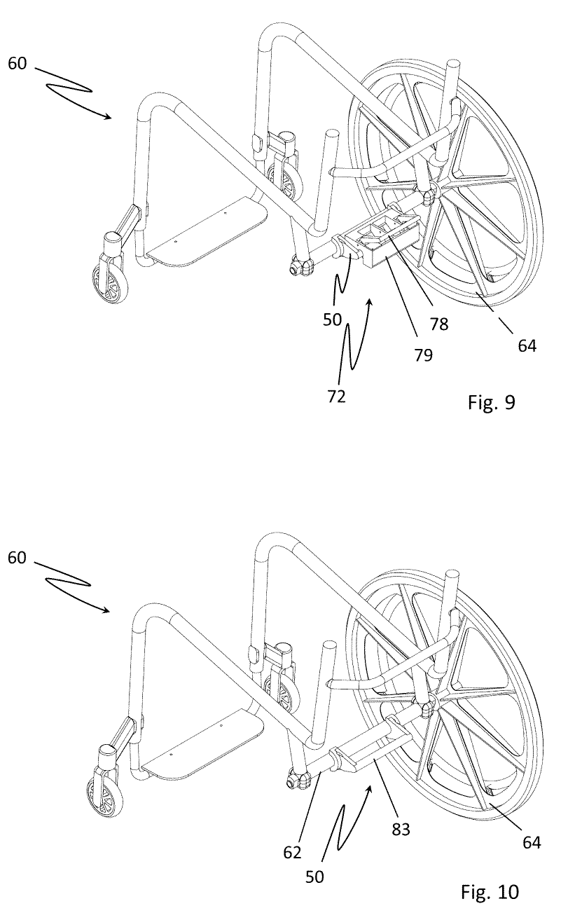

FIG. 9 shows an example of a fastening means 72 in a second embodiment. In this figure, the rest of the motor module is not shown and the chair 60 is only partially illustrated.

FIG. 10 shows an example of a fastening base 80 with a bar 83 as shown in the second embodiment. In this figure, the chair 60 is only partially shown

Advantageously, the attachment bar 83 is elongated along a longitudinal axis of the attachment bar substantially parallel to the longitudinal axis of the frame 62 when the fastening base 80 is attached to the frame 62.

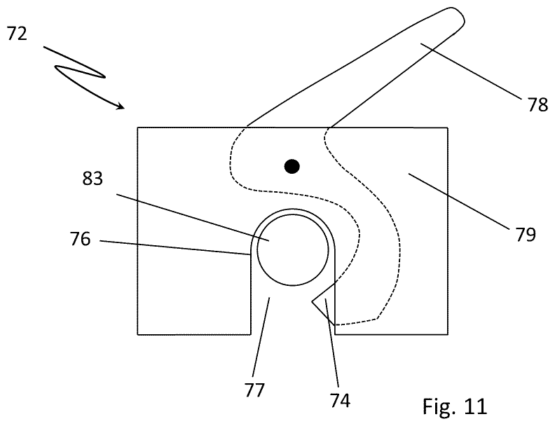

FIG. 11 shows a profile view of the removable fastener 72 and part of the fastening base 80. This design differs from the previous one in that attachment means 72 feature a movable hook 74.

Fastening means 72 and fastening base 80 are intended to cooperate to establish a pivot connection between fastening means 72 and fastening base 80.

In the second embodiment, the attachment means 82 of the fastening base 80 comprises at least one attachment bar 83.

The removable fastening means 72 comprises at least one hook 74 which is movable relative to a frame 79 of said removable fastening means 72. Advantageously, the removable fastening means 72 comprises at least one stop 76. The hook 74 is preferably movable between a first position in which it is distant from the stop and a second position in which it is closer to the stop.

For example, hook 74 can be rotated relative to frame 79 about an axis of rotation of hook 74.

Advantageously, the axis of rotation of hook 74 is substantially parallel to the axis of rotation of the pivot connection when the removable pivot connection between removable fastening means 72 and base 80 is formed.

For example, the axis of rotation is intended to be substantially parallel to the longitudinal axis of the bar 83 when the removable pivot connection between the removable fastening means 72 and the base 80 is formed.

According to an embodiment, the removable fastening means and more particularly the assembly formed by the stop 76, the hook 74 and the frame 79 form a jaw comprising a cavity 77 designed to receive the bar 83, the jaw being configured to clamp the bar 83 of the fastening base 80 received in the cavity when the hook is in the second position.

Thus, when the hook 74 is in the first position, it is possible to arrange the releasable fastening means 72 around the bar 83, i.e. to insert the bar 83 into the cavity 77, with the stop extending on one side of the bar and the hook extending on another side of the bar. The hook 34 is then placed in its second position so that the releasable fastening means clamps the bar 83, thereby establishing the pivot connection between the releasable fastening means 72 and the base 80.

In this way, the motor module 20 is held on the fastening base 80.

In one embodiment, the hook 74 is integral with a handle 78. Advantageously, the handle 78 is used to grip the motor module in order to carry it, and/or to attach or detach it from the fastening base 80.

Advantageously, the assembly formed by the hook 74 and the handle 78 is fixed to the frame 79 by a pivot connection with an axis parallel to a longitudinal axis of the bar 83 when the removable fixing means 72 and the fastening base 80 are connected.

In this way, when the user grips the handle to carry the motor module 20, the hook 74 rotates from the second position to the first position under the effect of the weight of the motor module 20. Thus, when the motor module 20 is attached to the fastening base, the user's grasp of the handle to carry said module disengages the hook 74 and releases the attachment of the motor module 20 to the fastening base 50.

In one embodiment, the motor module 20 has at least one stand.

A kickstand is a substantially rod-shaped mechanical part that is movable relative to the housing 30 between a retracted and an extended position. When in the deployed position, it provides support for the motor module 20, enabling it to remain in place when placed on the ground.

In one embodiment, the support leg is in a retracted position along the housing 30. In one embodiment, the support leg is linked to the housing 30 by a pivot connection. In this way, the lever handle can be rotated between the extended and retracted positions about the axis of the pivot relative to the housing 30.

In one embodiment, the kickstand is connected to the handle 78. In this mode, the landing gear automatically switches from the retracted position to the extended position when the user carries the motor module 20 by the handle.

In one embodiment, the motor module 20 has at least two stands

In one embodiment, the crutch or crutches are removable. In other words, the kickstand(s) is/are removably or dismountably mounted on the housing. In this way, a user can decide to remove them from the motor module if they are not needed.

### Controls and Interfaces

Advantageously, the assistance system 10 includes a controller configured to control the operation of the first motor 46 and/or the operation of the second motor 48. More specifically, the controller controls the control of the electric motors 46, 48.

In one embodiment, the controller comprises a set of at least one computer. The ECU is configured to receive information from the sensor(s) of the system 10. Advantageously, the set of at least one computer is configured to control the first motor 46 and/or the second motor 48 as a function of the information supplied by the sensors.

In one embodiment, the controller comprises a user interface enabling a user to control the rotation of the wheel 40 about the first axis of rotation A₁ and about the second axis of rotation A₂. Thus, the interface enables the user to control the speed and trajectory of the wheelchair 60 on which the assistance system 10 is installed.

In other words, the user interface enables a user to transmit input information to the controller and, more specifically, to an ECU in the set of at least one ECU. The information sent to the controller and more particularly to the ECU enables the ECU to generate commands for the first motor and/or the second motor.

In one embodiment, the user interface is fixed to the wheelchair 60, preferably close to an armrest or to an area towards which a user's arm is directed when seated on the wheelchair 60

In one embodiment, the user interface is removably attached to the wheelchair 60.

In one embodiment, the user interface is permanently attached to the wheelchair 60

In one embodiment, the user interface can be detached from the wheelchair 60. In one embodiment, the user interface is a remote control. This arrangement enables the user to hold the user interface in his or her hand. According to one embodiment, the user interface comprises an accelerometer. The accelerometer preferably controls the operation of system 10. This arrangement enables the user to control the movement of the chair 60 by tilting the user interface. In one embodiment, the user interface comprises a joystick enabling the user to control the trajectory of the wheelchair 60.

In one embodiment, the controller features a touchpad. A touchpad is a surface, generally rectangular, on which the user can act tactilely with a finger. Advantageously, the position of the user's finger on the touchpad can be used to control the wheelchair's speed. Advantageously, the position of the user's finger on the touchpad can be used to control the direction of the wheelchair 60.

In one embodiment, the controller is wired to the motor module 20. According to one embodiment, the controller comprises at least one magnet configured to cooperate with a magnet of a connection cable. In this way, when the cable is connected to the electrical connection, it is held in the connection by magnetic interaction. In the same way, abrupt removal of the cable from the connection is possible without damaging the cable and/or the electrical connection. The cable can thus be used to transmit control information to the electric motors 46, 48. In one embodiment, when the battery of the assistance system 10 is located on the wheelchair 60, the battery is wired to the motor module 20. The battery thus supplies electrical power to the first and second motors 46, 48.

In one embodiment, the controller is connected to the motor module 20 by a cable passing close to the removable fastening means 32 and close to the attachment means 52 of the fastening base 50. In one embodiment, the housing 30 comprises a connector for connecting the cable linking the controller to the motor module. According to an embodiment, the connector of the 30 housing comprises a magnetic fastening means enabling the deployment of a holding force holding the connector of the 30 housing and a connection end of the cable. Advantageously, the magnetic fixing means is a magnet. According to one embodiment, the cable connection end comprises a magnetic fixing means enabling the deployment of a holding force holding the housing connector 30 and the cable connection end. Advantageously, the magnetic fixing means is a magnet. In one embodiment, the removable fastening means 32 comprises a connector. In this way, the connection is made directly to the removable fixing means. The connector of the removable fixing means is connected by wire to the electric motors 46, 48 and to all the electronic equipment to be controlled in the motor module 20.

In one embodiment, the fastening base and/or removable attachment means comprise a magnetic presence sensor. The magnetic sensor is configured to detect the presence of the removable fixing means on the fastening base.

In one embodiment, presence information is supplied by the magnetic sensor to the controller.

The system can include means for routing the sensor presence signal to the user interface. These may be electrical means such as an electrical cable or a wireless interface.

In one embodiment, the presence information is transmitted to the user interface by the central unit.

Advantageously, the user interface comprises a screen.

The user interface can be configured to display an indicator, such as a light or symbol, enabling a user to check that the motor module is correctly installed on the fastening base.

In particular, the user interface is configured to display motor module presence information and possibly any other information that may be received by the user interface.

In one embodiment, the user interface comprises at least one indicator light, such as a light-emitting diode. In this case, the LED lights up when the user interface receives presence information.

In one embodiment, the display shows the user any useful information about the system's operation. For example, the display shows the state of charge of the system battery.

According to one example, the user interface includes a command for performing the switch function to energize the battery and/or, more generally, any energy source supplying the motor module. Such a control can be engaged either by a mechanical actuator or a digital control of the user interface.

In one embodiment, the attachment means 52 of the fastening base 50 comprises a connector. The connector on the fastening base is wired to the controller and/or battery. Advantageously, the attachment means 52 and the fixing means each comprise a connector. When the motor module 20 is assembled on the fastening base, the two connectors are brought into contact. As a result, the motor module 20 and the controller are wired together. This arrangement is particularly advantageous, as it enables the motor module 20 to be mechanically connected to the wheelchair 60 in a single assembly operation, and the motor module to be electrically connected to the equipment on the wheelchair 60. Such equipment includes, for example, the controller and/or the battery, when the latter is located on the wheelchair.

In one embodiment, the controller is wirelessly connected to the motor module 20. This arrangement avoids the need for a wired connection between the wheelchair 60 and the motor module 20. This arrangement also facilitates the use of a remote control as a controller. In this way, the user can hold the controller directly in his or her hand, without it being attached or connected to the wheelchair 60 by a cable.

In one embodiment, the wireless connection is a radio wave connection. In one embodiment, the wireless connection is a Bluetooth® protocol connection. In one embodiment, the wireless connection is a wifi connection.

In one embodiment, the controller is a smartphone. The advantage of this is that you can control the assistance system via your phone, without having to install an external controller on wheelchair 60. In one example, the phone includes an application for wireless control of the controllable elements of the assistance system 10.

In one example, the phone can connect to the assistance system via a connection described above. The telephone connects to a web page enabling control of the assistance system 10, in particular control of the movement of the wheelchair 60 on which the system 10 is installed.

In one embodiment, a control interface is displayed on the smartphone screen. Advantageously, the control interface comprises a number of directional arrows enabling the wheelchair 60 to be moved forwards, backwards and around corners by tactile interaction. In other words, the directional arrows can be used to control the operation of the first electric motor 46 and the second electric motor 48. In one example, the interface includes a touch zone acting as a touchpad for controlling the assistance system 10. The touchpad is used to set the forward, reverse and rotation speeds of the wheelchair 60 on which the system is installed. Advantageously, the touchpad also enables the user to control the speed of the assistance system 10, by moving his finger more or less forward on the touchpad. Similarly, the user can control the angle of rotation of the wheel 40 about the second axis of rotation A₂ by moving his finger more or less on the touchpad relative to a central point of said pad.

### NOMENCLATURE

10: manual wheelchair assistance system
20: assistance system motor module
30: case
32: removable fastening means
34: fastener hook
36: fastener stop
40: wheel
41: impeller shaft
42: wheel tire
44: fork
46: first motor
48: second motor
50: fastening base
52: attachment means of the fastening base
54: fastener rod
56: fastener cavity
58: fastening part of fastening base
59: mooring part of fastening base
60: manual wheelchair
62: manual wheelchair frame
64: wheelchair main wheels
70: housing according to a second embodiment of the invention
72: removable fastening means according to the second method of construction
74: hook of the removable fastening means according to the second mode
76: stop
77: removable fastener cavity
78: handle
79: removable fastener frame
80: fastening base according to the second construction method
82: means for attaching the fastening base according to the second design mode
83: bar of the fastening base
A₁: first axis of rotation
A₂: second axis of rotation
C: wheel center point

1. An assistance system for a manual wheelchair comprising a fastening base configured for being fixed to a frame of a manual wheelchair, a battery, a motor module, said motor module comprising:
a housing;
a removable fastening means configured to cooperate with an attachment means of the fastening base;
a wheel fixed in translation relative to the housing;
at least one first electric motor;
the first electric motor being configured to drive the first wheel in rotation about a first axis of rotation, the assistance system further comprising means for controlling the first motor, and a second electric motor configured to drive the wheel in rotation about a second axis of rotation perpendicular to the first axis.

2. The assistance system according to claim 1, wherein the wheel is in contact with a surface of a floor on which the wheelchair is placed when the motor module is attached to the fastening base.

3. The assistance system according to claim 2, wherein the first motor is integrated into the wheel.

4. The assistance system according to claim 1, wherein the second motor is integrated with the housing.

5. The assistance system according to claim 1, wherein the removable fastening means comprises at least one hook, and wherein the attachment means comprises at least one rod configured to cooperate with the hook to connect the removable fastening means and the attachment means in a removable manner.

6. The assistance system according to claim 1, wherein the first axis of rotation of the wheel is perpendicular to a principal plane of said wheel, and wherein the first electric motor is controlled in speed, position and/or torque to drive the rotation of the wheel about the first axis of rotation with respect to the housing in a first direction and/or in a second direction opposite to the first direction.

7. The assistance system according to claim 6, wherein braking by the first motor is regenerative braking for recharging the battery of the assistance system.

8. The assistance system according to claim 1, further comprising a controller configured to control the rotation and/or braking of the first motor.

9. The assistance system according to claim 8, wherein the removable fastening means and/or the attachment means comprises at least one magnet configured to maintain contact between a contactor of the attachment means and a contactor of the removable fastening means.

10. The assistance system according to claim 8, comprising a user interface enabling a user to send at least one setpoint, the controller being configured to control operation of the first motor as a function of the setpoint.

11. A manual wheelchair comprising the assistance system according to claim 1 and wherein the fastening base is fixed to a frame of the manual wheelchair.
